(19) United States
(12) Patent Application Publication
(10) Pub. No.: US 2006/0238490 A1
(43) Pub. Date: Oct. 26, 2006

(54) Non contact human-computer interface

(75) Inventors: Maurice Stanley, Worcester (GB); David Charles Scattergood, Worcester (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Qinetiq Limited

(21) Appl. No.: 10/555,971

(22) PCT Filed: May 12, 2004
(86) PCT No.: PCT/GB04/02022

§ 371 Date: Nov. 8, 2005

(30) Foreign Application Priority Data
May 15, 2003 (GB) 0311177.0

(51) Int. Cl. G09G 5/00

(52) U.S. Cl. 345/156

(57) ABSTRACT

A human-computer interface includes a plurality of transducers comprising of emitters ad transducers arranged to detect patterns relating to movement of an object such as a gesture or a user's hand within a detection volume in the vicinity of the transducers, and to provide an input to computer equipment depending on the pattern detected. The interface may perform a simple analysis of the date received by the transducer to detect basic gestures, or it may perform a more complex analysis to detect a greater range of gestures, or more complex gestures. The transducers are preferably infra-red or ultrasonic transducers, although others may be suitable. The transducers may be arranged in a linear, a two-dimensional, or a three-dimensional pattern. Signals emitted by emitters may be modulated to aid gesture identification. The computer equipment may be a standard computer, or may be a game machine, security device, domestic appliance, or any other suitable apparatus incorporating a computer.

This invention relates to non contact human-computer interfaces. More specifically, it relates to interfaces of the type whereby gestures made by a user may be detected and interpreted by some means, and the gestures used to affect the operation of a computer, or computer controlled equipment.

A mouse is a device commonly employed on modern computer systems as a means for controlling the operation of a computer system. Such devices typically sit beside a computer keyboard and allow a user to, for example, select options appearing upon a display system. A user of such a device must reach over to it, and then click or drag etc to carry out the desired action as required by the software running on the computer. Usually knowledge of the whereabouts on the display of the pointer corresponding to the mouse position will be needed. However, certain software applications do not require this, and the required input from the user will be, for example, a left click or a right click to advance or back up through a set of slides, or to start or stop an animation appearing on a display. If the user is giving a presentation, or is concentrating particularly hard on whatever is appearing on the display, the inconvenience of locating the mouse to press the appropriate button may not be desirable, so for this reason some sort of gesture recognition system is useful.

U.S. Pat. No. 6,222,465 discloses a Gesture Based Computer Interface, in which gestures made by a user are detected by means of a video camera and image processing software. However, the video system and related processing are complex and expensive to implement, and are sensitive to lighting conditions and unintentional movements of the user. Some such systems also have a latency between the user movement and that movement being acted upon by client program due to the high processing requirements.

A simpler system of detecting gestures is provided by U.S. Pat. No. 5,990,865, which discloses a capacitive system whereby the space between the plates of a capacitor define a volume, in which movement of, say, an operator's hands can be detected by the change in capacitance. This however suffers from the problem of having very poor resolution—a movement can be detected, but it will not be known what that movement is. It would have difficulty distinguishing, for example, a large finger movement from a slight arm movement. Furthermore, for large volumes the capacitance is very small and subsequently hard to measure, leading to noise and sensitivity problems.

According to the present invention there is provided a human-computer interface device for detecting a gesture made by a user comprising of a plurality of transducers including at least one emitter and at least two detectors characterised in that the detectors are arranged to detect signals transmitted by the at least two emitters and reflected from an object within a detection volume in the vicinity of the transducers, and to pass information relating to the detected signals into an electronic control system, where the information relating to the signals is arranged to be processed to detect patterns relating to movement of the object in the detection volume, and the electronic control system is arranged to communicate with a host computer system in a manner defined by the patterns detected.

The transducers may be any suitable transducer capable of transmitting or receiving signals which can be reflected from an object, such as an operator's hand, within the detection volume. Preferably, the transducers are infra-red or ultrasonic transducers, although visible transducers may also be used. Such transducers are very low cost, and so an array of such transducers can be incorporated into a low cost interface suitable for non-specialist applications. There may be approximately two, five, ten, twenty, forty or even more emitters and detectors present in the array. The detectors may be fitted with optical or electronic filter means to suppress background radiation and noise.

The transducers may be arranged within a housing that further contains the electronics associated with driving the emitter(s), receiving the signals from the detectors, and processing the received signals. The transducers may be arranged within this housing in a linear pattern, in a two dimensional pattern, in a three dimensional pattern, or in any other suitable configuration. The housing may also form part of some other equipment such as a computer monitor or furniture item, or may form part of the fabric of a building, such as wall, ceiling or door frame. The layout pattern of the transducers may be governed by the situation in which they are mounted.

The transducers may be controlled by their associated electronics such that the signals received by the detectors from within the detection volume may be decoded to identify the emitter from which they came. This control may take the form of modulation of the emitted signals, or of arranging the frequencies of the signals generated by the emitters to be different for each emitter. The modulation may take the form of pulse modulation, pulse code modulation, frequency modulation, amplitude modulation, or any other suitable form of modulation.

The control electronics may be arranged to interpret the signals received by the detectors to look for particular returns indicative of a gesture made by a user. A gesture may comprise of a user placing or moving an object such as his or her hand within the detection volume in a given direction or manner. For example, a user may move his hand from left to right above the transducers, or from right to left. A gesture may also comprise of other movements, such as leg or head movements. The control electronics may be programmed to interpret the signals received from the detectors as equivalent to moving a computer mouse or joystick to the right (or making a right mouse click), or moving a computer mouse or joystick to the left (or making a left mouse click), respectively, and may then be arranged to input data into a computer system similar to that that would be produced by a mouse movement or mouse button click. In this manner the gesture interface of the current invention may be used in a computer system in place of buttons on a mouse. Visual or audio feedback may be provided for ease of use of the system.

Of course, more complex gestures than this may be interpreted by the interface of the current invention provided the electronic control system processing the signals received by the detectors is able to resolve the different gestures. The electronic control system may be a basic system for recognising a small number of gestures, or may be a complex system if a larger number of gestures are to be recognised, or if the gestures differ from each other in subtle ways. Information relating to signals received from the detectors may provide inputs to a neural network system programmed to distinguish a gesture input to the interface.

The transducers may be arranged to measure the range or position of an object within the detection volume, thus allowing more complex gestures to be resolved. This may be done using standard techniques such as phase comparison of any modulation decoded from a received signal, or relative strength of the transmitted signal itself. If ultrasonic transducers are used then measurement of the time of flight may be used to measure the range. The transducers may also be arranged to measure the position of an object within the detection volume on a plane parallel to that of the transducer array. This allows the position of the object to form part of the gesture information. The time taken for an object to move between positions—i.e. the velocity—may also form part of the gesture information.

The interface device may be arranged to learn gestures input from a user, and may be further arranged to associate a particular command with a gesture, such that the command associated with a given gesture may be reprogrammed as desired by the user.

As an alternative to the implementation described above, the transducer arrangement may comprise at least two emitters and at least one detector. An object within a detection volume may reflect a signal or signals from one or more of the emitters to the at least one detector according to the position and velocity at a given instant of the object. The received signal or signals may be interpreted in the manner as described above to detect a gesture made by the object.

According to a second aspect of the current invention there is provided a method of generating an input signal for a host computer system comprising the steps of:

transmitting at least one signal into a detection volume using at least one emitter, and receiving at least one signal from the detection volume using at least one detector;

passing any received signals to an electronic control system;

detecting patterns of movement within the electronic control system;

communicating with the host computer system in a manner dependent upon the patterns detected.

The invention will now be described in more detail, by way of example only, with reference to the following Figures, of which:

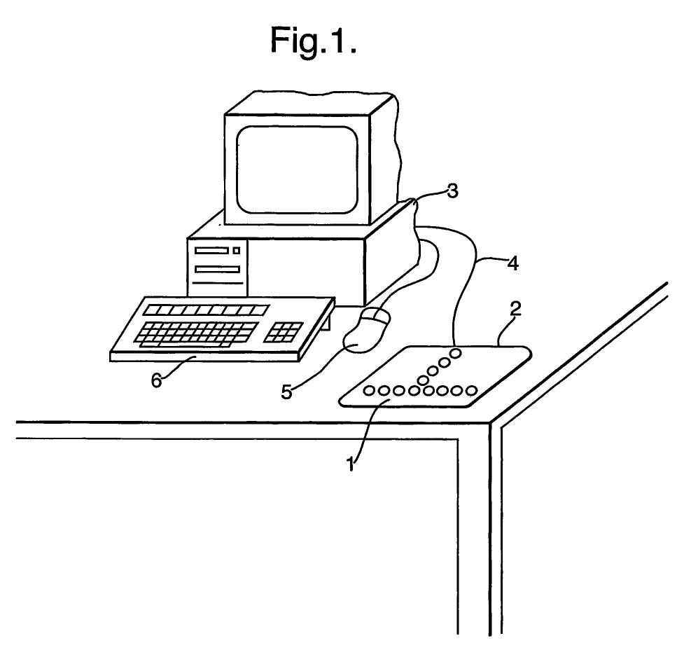

FIG. 1 diagrammatically illustrates a first embodiment of the current invention connected to a computer system;

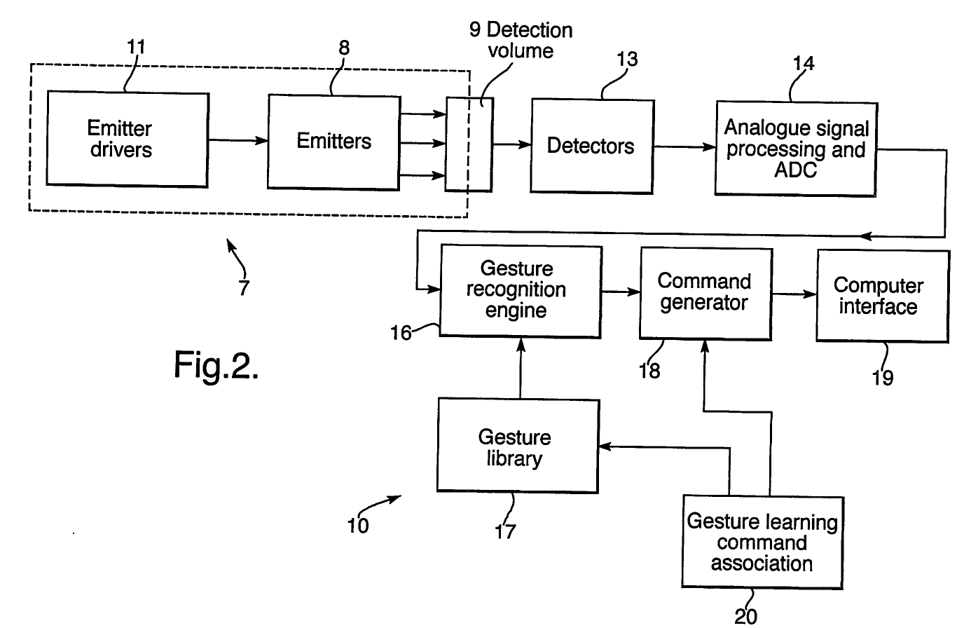

FIG. 2 shows a block diagram of the first embodiment and its connections to a computer system; and

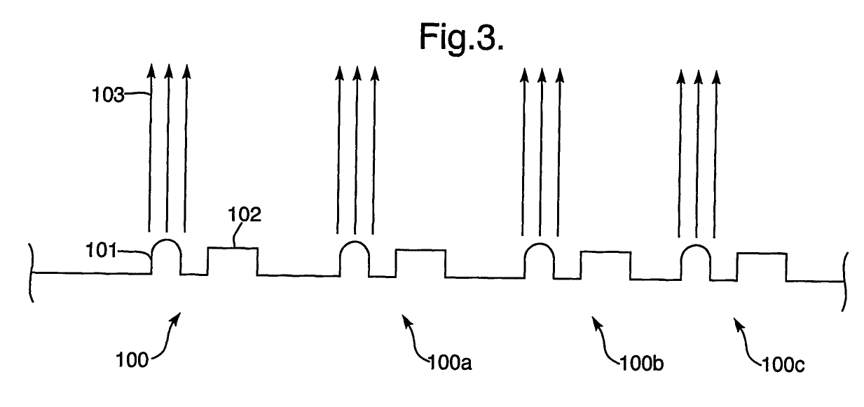

FIG. 3 diagrammatically illustrates the transducer arrangement on a third embodiment of the current invention;

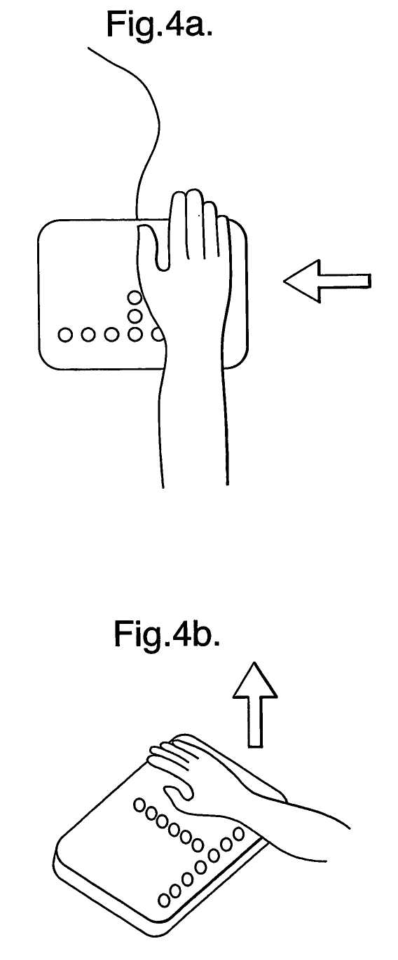

FIG. 4 diagrammatically illustrates two typical gestures that may be used with the current invention.

FIG. 1 shows a first embodiment of the current invention, comprising an array of transducers 1 mounted in a housing 2 connected to a computer system 3 via a USB cable 4. Also connected to the computer system 3 are a standard mouse 5 and a keyboard 6. The transducers 1 are arranged in a “T” shape, and are each in communication with control electronics (not shown) contained within the housing 2. Each emitter transducer is associated with its own detector transducer to form a transducer pair. The emitters produce IR radiation in a substantially collimated beam when suitably energised, and the detectors are sensitive to such radiation. The detectors are equipped with optical filters such that wavelengths other than those transmitted by the emitters may be reduced in strength, to suppress background noise. Control electronics (not shown) are arranged to drive the emitters, and process the signals received by the detectors, analysing the signals to detect whether a gesture has been input to the system, and, if so, what that gesture is.

A wireless interface e.g. Bluetooth or infra-red may also be used to link the sensor unit to the computer system, or any other suitable means may be used to implement this connection.

Once a gesture has been identified, a command associated with the gesture is communicated to the computer system 3 via the USB cable 4, where software running on the computer system 3 acts as appropriate to the command in a similar manner to if a command were sent by a standard data input device such as the mouse 5 or keyboard 6, although of course then the command may be different.

FIG. 2 shows a block diagram of the operation of the first embodiment of the invention. The circuitry associated with the emitter side of the transducers is shown within the dotted area 7, whilst the circuitry associated with the detectors, gesture recogniser and computer interface is indicated in the remaining part of the diagram 10.

The emitters 8 comprise infra-red (IR) LEDs arranged to transmit IR energy up into a detection volume 9. The IR LEDs themselves are driven in a standard manner by emitter driver circuitry 11.

An array of detectors is arranged to receive IR radiation from the vicinity of the detection volume. These detectors 13 provide the received signals to an analogue signal processing circuit 14 and then to an Analogue to Digital Converter (ADC) 14, which is in turn connected to a Gesture recognition engine 16. The engine 16 also takes inputs from a gesture library 17, which stores signals relating to gestures input to the interface during a training phase. A command generator 18 takes the output from the engine 16 and is connected to computer interface 19.

The operation of the interface is as follows. IR energy is transmitted by the emitters 8 into the detection volume 9 lying directly above the transducer array. An object present in the detection volume will tend to reflect signals back to the transducers where they will be detected by the detectors 13. The relative received signal strength could be used as a coarse indicator of which transducer the object is closest to, so giving a coarse indication of the position of the object. Any detected signals are passed to the analogue signal processing and ADC 14, where they are amplified and converted to digital format for ease of subsequent processing. From there, the digital signals are input to a gesture recognition engine 16. This engine 16 compares the signals received against stored signals generated during a training process. If a sufficiently close match is found between the current set of inputs and a stored set of inputs, then it is assumed that a gesture corresponding to stored signals closest to the current input signals is the gesture that has been made. Details relating to this gesture are then sent to a command generator, which is a look-up table relating the stored gestures to a given command recognisable by the host computer (item 3 of FIG. 1). This command is then transmitted to the computer 3 by means of the computer interface 19.

The training process associated with the current embodiment operates as follows. On entering the training mode via software running on the host computer 3 and under the control of the gesture learning and command association unit 20, samples of a gesture are made in the detection volume, and are suitably annotated by the user, for example, “RIGHT MOVEMENT”. The digital signals generated by these samples are then stored in the gesture library. Commands to be associated with the gesture are then input to the computer, by selecting from a choice of commands presented on the host computer. This process is repeated for various gestures, and the data likewise stored, thus building up a table of gestures and associated commands.

The first embodiment employs a gesture recognition engine in which the current input data is correlated using known methods such as those mentioned in Kreysig, E, Advanced Engineering Mathematics, 8^{th} Ed, Wiley, against the gesture data stored in the gesture library, and the gesture with the lowest correlation distance is chosen as the most likely gesture to have been made by the user. There is also a maximum correlation distance threshold, such that if the lowest correlation distance is greater than this threshold value, no gestures are chosen. In this way, false recognition of gestures is reduced, and the system reliability is increased.

A second embodiment employs a more complex gesture recognition system, whereby a gesture library in the form described above is not required. This system uses a neural network to analyse the data input from the detectors, and to estimate the most likely gesture made from a library of gestures, and then to output a command to the host computer associated with that gesture. This second embodiment can therefore store many more gestures in an equivalent memory space to that used for the first embodiment. Details of suitable neural network techniques for implementing the current invention can be found in Kohonen, T, “Self Organisation & Associative Memory”, 3^{rd} Edition, Berlin Germany, 1989, Springer Verlag.

An arrangement of the emitter and detector pairs as is used in the above embodiments is illustrated in FIG. 3. Here, only four emitter-detector pairs 100 are shown for clarity, though of course there may be more than that in practice. The emitter 101 of each pair 100 outputs a substantially collimated IR beam 103 that is modulated with a PCM code unique to it amongst all other emitters on the system. The signal received by the detector can then be demodulated such that the system is able to discriminate between signals from different emitters. This is useful for identifying more accurately the position of an object within the detection volume. The collimation of the IR beam reduces the chance of signals from one emitter being picked up by a detector not associated with that emitter, and so makes the demodulation process simpler.

A fourth embodiment of the current invention processes the signals received from the detectors in a simpler manner to that described in the above embodiments. The embodiment digitises the signals received from the detectors and demodulates them to remove modulation applied to the emitted signals before passing this data to the host computer system. The host computer then does a simple analysis of the data to extract basic patterns. For example, if this embodiment were implemented on the hardware system of FIG. 3 then a left to right movement of one's hand through the detection volume would give a response from transducer 100, followed by a response from transducer 100a, then 100b, then 100c. This would be reflected in the digitised signals in a manner that could easily be distinguished by temporal comparison of each transducer output. Likewise, a right to left movement would give a corresponding but time-reversed response from the transducers.

FIG. 4 shows two gestures that may be used with the current invention. FIG. 4a shows a top view of a user moving his hand from right to left above an interface according to the present invention. The action this gesture may have on a computer program running on a host computer is programmable as described above, but could, for example, be equivalent to a right mouse click. FIG. 4b shows a second gesture whereby the user is raising his hand vertically upward away from the interface. Again, this gesture would be programmable, but may typically be employed to control the zoom factor of a graphical display program for example.

Other gestures may be used in combination with the gestures described above, or with any other gesture recognisable by the interface. For example, a pause at the end of the user's gesture, or a second hand movement following the gesture may be programmed to be interpreted as a mouse button click or equivalent to pressing the ‘enter’ button on a computer keyboard. Alternatively, this interface may be combined with additional functional elements eg an electronic button or audio input to achieve the functionality of computer mouse buttons.

Advantageously the computer system may be arranged to provide visual or audible feedback to indicate that a gesture has been recognised, or alternatively that a gesture has not been recognised, and so needs to be repeated. For example a green light may be used to show that a movement is currently in the process of being interpreted. Each time a gesture is completed, indicated by, for example, a pause in the movement, the light may be arranged to then to change colour to indicate either that the gesture has been recognised or that repetition is required.

The skilled person will be aware that other embodiments within the scope of the invention may be envisaged, and thus the invention should not be limited to the embodiments as herein described. For example, although the invention is shown being used on a general purpose computer system, it could also be used on specialist computer equipment such as games consoles, computer aided design systems, domestic appliances, public information systems, access control mechanisms and other security systems, user identification or any other suitable system.

1. A human-computer interface device for detecting a gesture made by a user comprising of at least three transducers each adapted to be one of an emitter and a detector, and comprising at least one emitter and at least one detector, characterised in that the detector(s) are arranged to detect signals transmitted by the emitter(s) and reflected from an object within a detection volume in the vicinity of the transducers, and to pass information relating to the detected signals into an electronic control system, where the information relating to the signals is arranged to be processed to detect patterns relating to movement of the object in the detection volume, and the electronic control system is arranged to communicate with a host computer system in a manner defined by the patterns detected.

2. (canceled)

3. A human-computer interface as claimed in claim 1 wherein the electronic control system is implemented within the host computer.

4. A human-computer interface as claimed in claim 1 wherein each transducer comprises a detector and an emitter.

5. A human-computer interface as claimed in claim 1 wherein the transducers are arranged in a linear array.

6. A human-computer interface as claimed in claim 1 wherein the transducers are arranged in a two dimensional array.

7. A human-computer interface as claimed in claim 1 wherein the transducers are arranged in a three dimensional array.

8. A human-computer interface as claimed in claim 1 wherein, where the interface has at least two emitters the signal transmitted from each emitter is arranged to have at least one characteristic different from the signals transmitted by the other emitters.

9. A human-computer interface as claimed in claim 8 arranged such that at a given instant in time each emitter transmits a signal at a frequency not used by any other emitter at that instant.

10. A human-computer interface as claimed in claim 8 wherein each emitter is modulated with a modulation signal different from that used on any other emitter.

11. A human-computer interface as claimed in claim 8 wherein the emitters are arranged to be pulse modulated such that not all emitters are emitting a signal at a given instant.

12. A human-computer interface as claimed in claim 8 wherein the emitters are arranged to be pulse modulated such that only a single emitter is emitting a signal at a given instant.

13. A human-computer interface as claimed in claim 1 wherein the transducers are ultrasonic transducers.

14. A human-computer interface as claimed in claim 1 wherein the transducers are infra-red transducers.

15. A human-computer interface as claimed in claim 1 wherein the interface is arranged to detect a distance separation between a transducer and an object in the detection volume.

16. A method of generating an input signal for a host computer system comprising the steps of:
transmitting at least one signal into a detection volume using at least one emitter, and receiving at least one signal from the detection volume using at least one detector;
passing any received signals to an electronic control system;
detecting patterns of movement within the electronic control system;
communicating with the host computer system in a manner dependent upon the patterns detected.
